(19) United States
(12) Patent Application Publication
(10) Pub. No.: US 2007/0046033 A1
(43) Pub. Date: Mar. 1, 2007

(54) Electronic device and latch structure thereof

(75) Inventor: Sheng Wangchen, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/503,984

(22) Filed: Aug. 15, 2006

(30) Foreign Application Priority Data
Aug. 15, 2005 (TW) 094127782

(51) Int. Cl. E05C 19/10

(52) U.S. Cl. 292/98

(57) ABSTRACT

A latch structure is installed in a first casing and a second casing. The first casing and the second casing are pivoted together and respectively have an opening and a locked portion. The latch structure includes a locking member, a pressing assembly and at least one elastic member. In this case, the locking member has a first guide portion and a hook portion. The pressing assembly has a pressing member and a connecting member. The pressing member is connected with the connecting member, and a second guide portion is disposed on a surface of the connecting member. The pressing member passes through the opening of the first casing, and the connecting member passes through the first guide portion of the locking member so that the first guide portion is positioned correspondingly with the second guide portion. One side of the elastic member is connected with the pressing assembly and the other side of the elastic member is connected with the first casing. When an external force is applied to the pressing member and the pressing member moves in a first direction, the hook portion is moved to a first position and locked with the locked portion of the second casing.

### BACKGROUND OF THE INVENTION

1. Field of Invention

The invention relates to a hook structure, and, in particular, to a latch structure used in an electronic device.

2. Related Art

The notebook computer mainly has a host and a liquid crystal display. A locking assembly is installed in the notebook computer to lock the liquid crystal display and the host. Herein, the locking assembly can prevent the liquid crystal display from being unintentionally opened.

Please refer to FIG. 1, a conventional electronic device 1 has a liquid crystal display 11, a host 12 and a locking assembly 13. The locking assembly 13 includes a hook 131, a slot 132 and a push-button 133. When the user locks the electronic device 1, the hook 131 installed in the liquid crystal display 11 hooks the slot 132 on the host 12. Consequently, the host 12 and the closed liquid crystal display 11 can be fixed, and the keyboard on the host 12 and the screen of the liquid crystal display 11 can be protected. Further, the electronic device 1 can be carried conveniently. When the user would like to open the electronic device 1, the user can push the pushbutton 133 connected with the hook 131 so as to release the hook 131 from the slot 2.

However, the hook 131 of the locking assembly 13 is exposed to the outside of the liquid crystal display 11. Hence, the hook 131 tends to deform or break if the user unintentionally touches the hook 131 when the notebook computer is opened.

In view of the above-mentioned problem, it is an important subject to provide an electronic device and a latch structure thereof capable of solving the problem caused by the exposed hook, which tends to deform and break, in the locking assembly.

### SUMMARY OF THE INVENTION

Therefore, the invention provides an electronic device and a latch structure thereof, in which a locking member is received in a first casing when the first casing and a second casing are opened.

The embodiment of the invention is to provide a latch structure installed in a first casing and a second casing. The first casing and the second casing are pivoted together and respectively have an opening and a locked portion. The latch structure includes a locking member, a pressing assembly and at least one elastic member. In this case, the locking member has a first guide portion and a hook portion. The pressing assembly has a pressing member and a connecting member. The pressing member is connected with the connecting member, and a second guide portion is disposed on a surface of the connecting member. The pressing member passes through the opening of the first casing, and the connecting member passes through the first guide portion of the locking member so that the first guide portion is positioned correspondingly with the second guide portion. One side of the elastic member is connected with the pressing assembly and the other side of the elastic member is connected with the first casing. When an external force is applied to the pressing member and the pressing member moves in a first direction, the hook portion is moved to a first position and locked with the locked portion of the second casing.

The embodiment of the invention is to provide an electronic device includes a first casing, a second casing and a latch structure. In this case, the first casing has an opening. The second casing has a locked portion and is pivoted on the first casing. The latch structure is installed in the first casing and the second casing. The latch structure has a locking member, a pressing assembly and at least one elastic member. The locking member has a first guide portion and a hook portion. The pressing assembly has a pressing member and a connecting member, and the pressing member is connected with the connecting member. A second guide portion is disposed on a surface of the connecting member. The pressing member passes through the opening of the first casing, and the connecting member passes through the first guide portion of the locking member so that the first guide portion is positioned correspondingly with the second guide portion. One side of the elastic member is connected with the pressing assembly and the other side of the elastic member is connected with the first casing. When an external force is applied to the pressing member and the pressing member moves in a first direction, the hook portion is moved to a first position and locked with the locked portion of the second casing.

In summary, each of the electronic device and the latch structure thereof according to the invention has the locking member and the pressing assembly, and the position of the first guide portion of the locking member corresponds to the position of the second guide portion of the pressing assembly. Compare with the prior art, the locking member can be accommodated in the first casing. When the external force is applied to the pressing assembly, the locking member is pushed out of the first casing to lock with the locked portion of the second casing.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional electronic device according to the prior art;

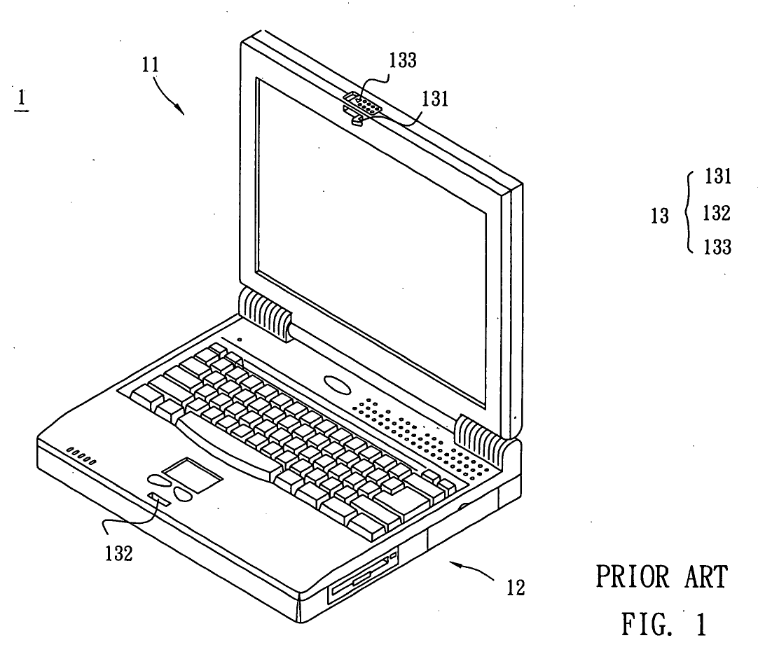

FIG. 2 is a schematic illustration showing a latch structure according to a preferred embodiment of the invention;

FIG. 3 is an exploded view showing the latch structure according to the preferred embodiment of the invention;

FIG. 4 is a schematic illustration showing a hook portion of the latch structure according to the preferred embodiment of the invention is moved to a second position;

FIG. 5 is a schematic illustration showing the hook portion of the latch structure according to the preferred embodiment of the invention is moved to a first position; and

FIG. 6 is a schematic illustration showing a positioning track member of the latch structure according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

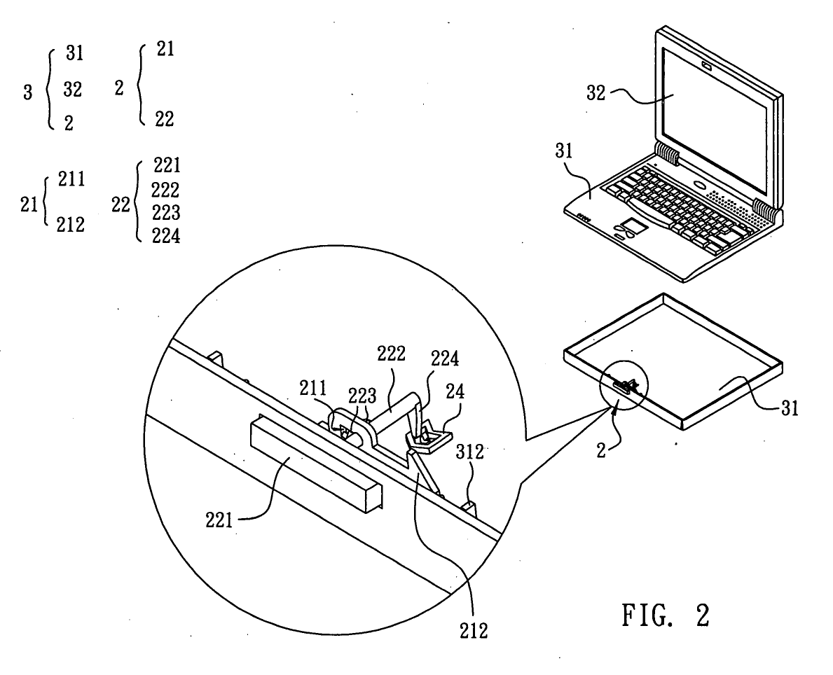

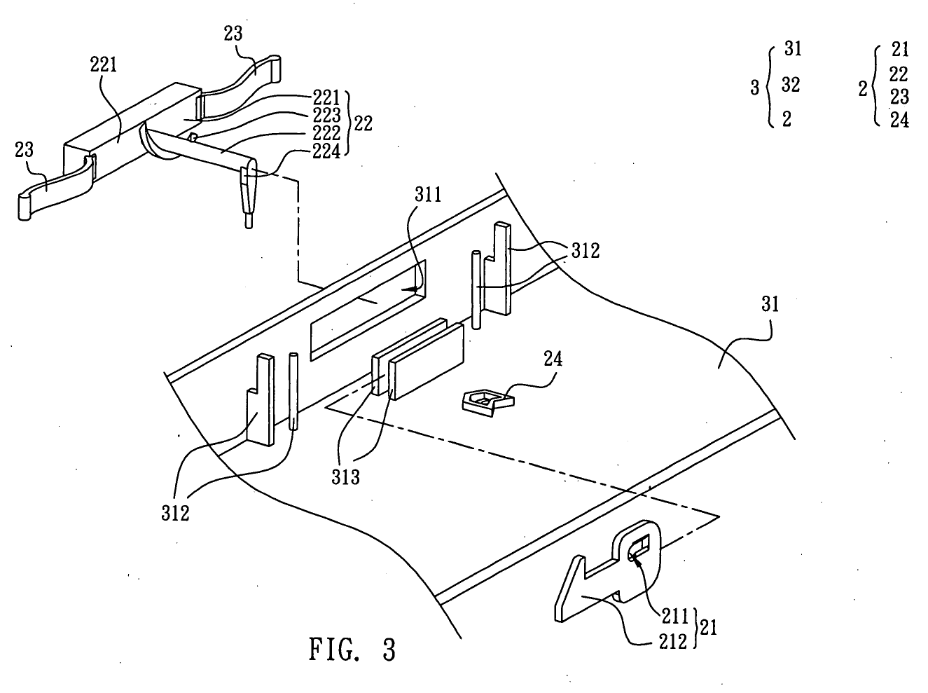

Referring to FIGS. 2 and 3, an electronic device 3 according to a preferred embodiment of the invention includes a first casing 31, a second casing 32 and a latch structure 2. The first casing 31 has an opening 311, the second casing 32 has a locked portion 321. Herein, the first casing 31 and the second casing 32 are pivoted together. The latch structure 2 includes a locking member 21, a pressing assembly 22 and at least one elastic member 23.

The locking member 21 has a first guide portion 211 and a hook portion 212. The pressing assembly 22 has a pressing member 221 and a connecting member 222, which is connected with the pressing member 221. A second guide portion 223 is disposed on a surface of the connecting member 222. Herein, the pressing member 221, the connecting member 222 and the elastic member 23 may be integrally formed.

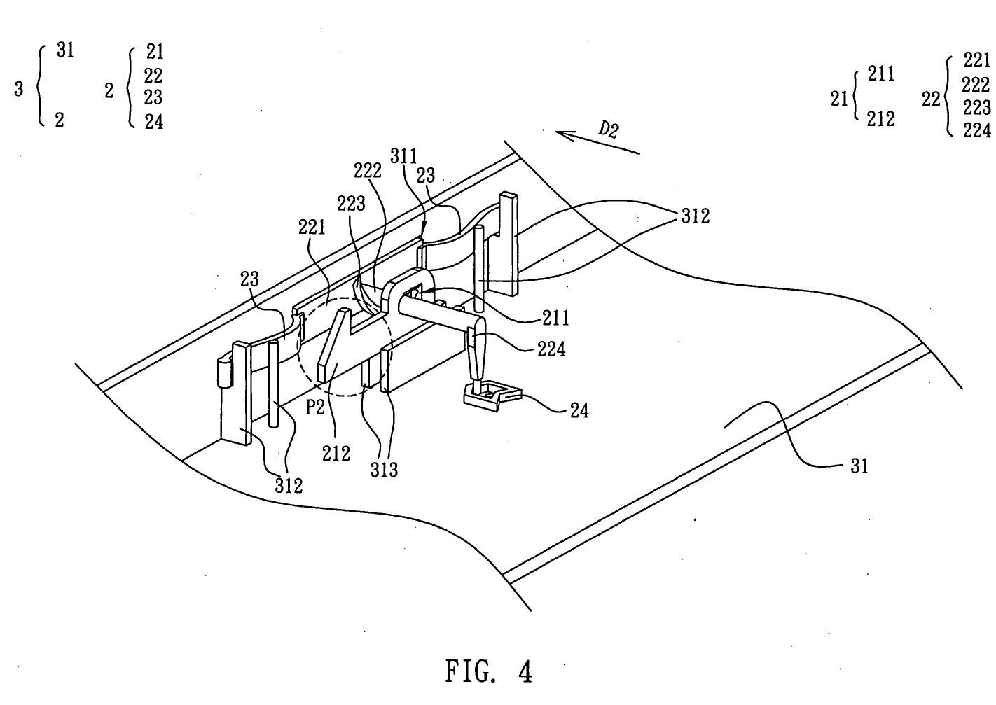

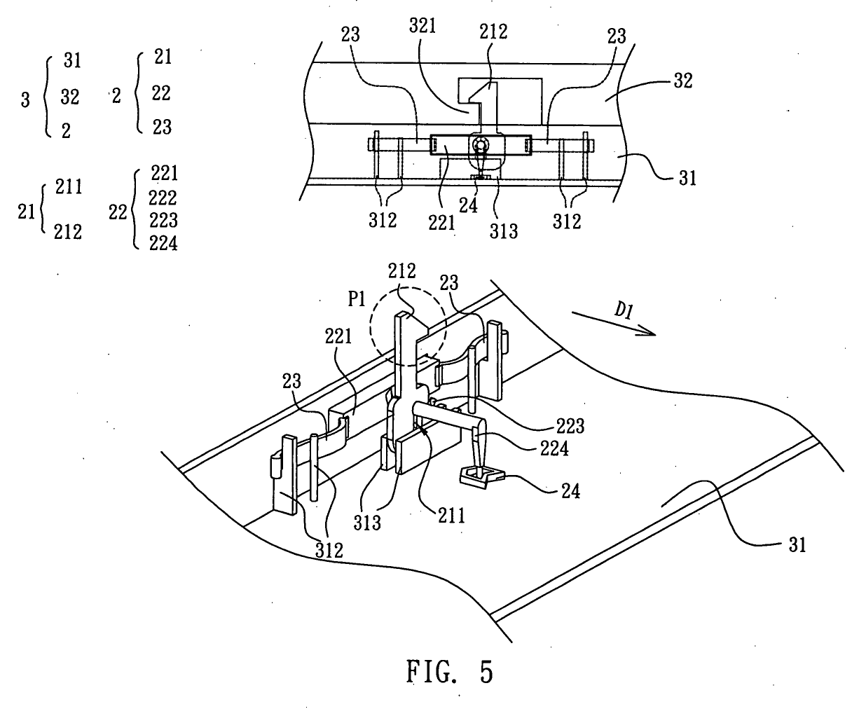

As shown in FIGS. 4 and 5, the pressing member 221 passes through the opening 311 of the first casing 31, and the connecting member 222 passes through the first guide portion 211 of the locking member 21 so that the first guide portion 211 is positioned correspondingly with the second guide portion 223. In addition, one side of the elastic member 23 is connected with the pressing assembly 22, and the other side of the elastic member 23 is connected with the first casing 31.

As shown in FIG. 5, when an external force is applied to the pressing member 221 and the pressing member 221 moves in a first direction D1, the hook portion 212 is moved to a first position P1 and is locked with the locked portion 321 of the second casing 32.

As shown in FIG. 4, when the hook portion 212 is located at the first position P1 and another external force is applied to the pressing member 221 to separate the hook portion 212 from the locked portion 321, a restoring force of the elastic member 23 moves the pressing member 221 in a second direction D2, and the hook portion 212 is moved to a second position P2. Herein, the second direction D2 is opposite to the first direction D1.

As shown in FIGS. 4 and 5, the second guide portion 223 in this embodiment may be a helical track, and the first guide portion 211 is a key-hole type through hole. Herein, the connecting member 222 and the second guide portion 223 pass through the first guide portion 211. When the connecting member 222 is moved in the first direction D1 or the second direction D2, the first guide portion 211 is rotated about the connecting member 222 along the second guide portion 223. Thus, the locking member 21 is also rotated about the connecting member 222, and the hook portion 212 is moved to the first position P1 or the second position P2.

In addition, the first guide portion 211 may also be a helical track, and the second guide portion 223 guides the first guide portion 211 to rotate (not shown).

In addition, as shown in FIG. 4, the elastic member 23 may be disposed on a lateral side of the pressing member 221. The first casing 31 has a stopping portion 312 and another stopping portion 313, and the other end of the elastic member 23 is connected with the stopping portion 312. When the pressing member 221 is moved in the first direction D1, the elastic member 23 produces the restoring force to move the pressing member 221 in the second direction D2 to the original position.

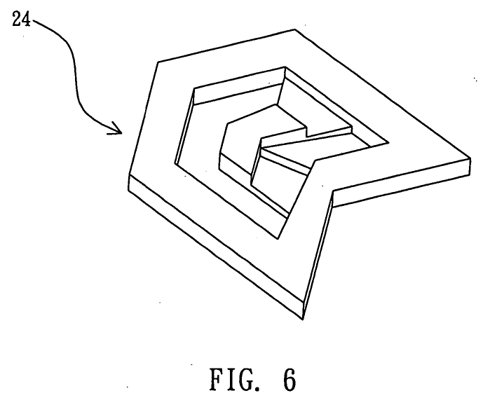

Furthermore, as shown in FIG. 6, the latch structure 2 may include a positioning track member 24, and the positioning track member 24 has a plurality of grooves with bottom surfaces at different levels. The pressing assembly 22 further includes a tracking member 224 connected with the connecting member 222. As shown in FIGS. 4 and 5, the tracking member 224 is moved along the positioning track member 24, such that the pressing assembly 22 is restrictively moved in the first direction D1 or the second direction D2, and the locking member 21 is moved between the first position P1 and the second position P2. The locking member 21 is disposed between the stopping portions 313 to prevent the locking member 21 from moving in the first direction D1 or the second direction D2.

For example, when the hook portion 212 is located at the second position P2, the first casing 31 and the second casing 32 are opened, and the hook portion 212 does not protrude beyond the first casing 31 and is free from being damaged. At this time, if the user closes the first casing 31 and the second casing 32 and presses the pressing member 221, the pressing member 221 and the connecting member 222 are moved in the first direction D1. The first guide portion 211 is rotated about the connecting member 222 along the second guide portion 223, and the locking member 21 is also rotated about the connecting member 222, so that the hook portion 212 is moved to the first position P1 and locked with the locked portion 321 of the second casing 32.

The elastic member 23 is disposed on the lateral side of the pressing member 221 and between the first casing 31 and the stopping portion 312. Hence, when the user wants to open the first casing 31 and the second casing 32 by pressing the pressing member 221, the elastic member 23 has the elastic restoring force to move the hook portion 212 to the second position P2 so that the first casing 31 and the second casing 32 can be opened.

An electronic device according to another embodiment of the invention includes a first casing, a second casing and a latch structure. In this embodiment, the first casing has an opening. The second casing has a locked portion and is pivoted on the first casing. The latch structure is installed in the first casing and the second casing. The latch structure has a locking member, a pressing assembly and at least one elastic member. The locking member has a first guide portion and a hook portion. The pressing assembly has a pressing member and a connecting member, and the pressing member is connected with the connecting member. A second guide portion is disposed on a surface of the connecting member. The pressing member passes through the opening of the first casing, and the connecting member passes through the first guide portion of the locking member so that the first guide portion is positioned correspondingly with the second guide portion. One side of the elastic member is connected with the pressing assembly and the other side of the elastic member is connected with the first casing. When an external force is applied to the pressing member and the pressing member moves in a first direction, the hook portion is moved to a first position and locked with the locked portion of the second casing.

The features and the functions of the latch structure, the first casing and the second casing in this embodiment are same as those of the latch structure, the first casing and the second casing in the above-mentioned embodiment, so detailed descriptions thereof will be omitted.

In summary, the electronic device and the latch structure thereof according to the invention have the locking member and the pressing assembly, and the first guide portion of the locking member is positioned correspondingly with the second guide portion of the pressing assembly. Compare with the prior art, the locking member can be accommodated in the first casing. When the external force is applied to the pressing assembly, the locking member is pushed out of the first casing to lock with the locked portion of the second casing.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A latch structure installed in a first casing and a second casing, which are pivoted together, the first casing having an opening, the second casing having a locked portion, the latch structure comprising:
a locking member, which has a first guide portion and a hook portion;
a pressing assembly, which has a pressing member and a connecting member, wherein the pressing member is connected with the connecting member, a second guide portion is disposed on a surface of the connecting member, the pressing member passes through the opening of the first casing, and the connecting member passes through the first guide portion of the locking member so that the first guide portion is positioned correspondingly with the second guide portion; and
at least one elastic member, one side of which connected with the pressing assembly and the other side of which connected with the first casing, wherein when an external force is applied to the pressing member and the pressing member moves in a first direction, the hook portion is moved to a first position and locked with the locked portion of the second casing.

2. The latch structure according to claim 1, wherein when the hook portion is located at the first position and another external force is applied to the pressing member to separate the hook portion from the locked portion, a restoring force of the elastic member moves the pressing member in a second direction, and the hook portion is moved to a second position opposite to the first direction.

3. The latch structure according to claim 1, wherein the first casing has a stopping portion connected with the elastic member.

4. The latch structure according to claim 1, wherein the elastic member is disposed on a lateral side of the pressing member.

5. The latch structure according to claim 1, wherein the pressing assembly further comprises:
a tracking member, which is connected with the connecting member.

6. The latch structure according to claim 5, further comprising:
a positioning track member, which has a plurality of grooves with bottom surfaces at different levels, wherein the tracking member is moved along the positioning track member.

7. The latch structure according to claim 1, wherein the first guide portion comprises a helical track, the second guide portion guides the first guide portion to rotate.

8. The latch structure according to claim 1, wherein the second guide portion comprises a helical track, the first guide portion is rotated along the second guide portion.

9. An electronic device, comprising:
a first casing, which has an opening;
a second casing, which has a locked portion and is pivoted on the first casing; and
a latch structure, which is installed in the first casing and the second casing, wherein the latch structure has a locking member, a pressing assembly and at least one elastic member, the locking member has a first guide portion and a hook portion, the pressing assembly has a pressing member and a connecting member, the pressing member is connected with the connecting member, a second guide portion is disposed on a surface of the connecting member, the pressing member passes through the opening of the first casing, and the connecting member passes through the first guide portion of the locking member so that the first guide portion is positioned correspondingly with the second guide portion, one side of the elastic member is connected with the pressing assembly and the other side of the elastic member is connected with the first casing, when an external force is applied to the pressing member and the pressing member moves in a first direction, the hook portion is moved to a first position and locked with the locked portion of the second casing.

10. The electronic device according to claim 9, wherein when the hook portion is located at the first position and another external force is applied to the pressing member to separate the hook portion from the locked portion, a restoring force of the elastic member moves the pressing member in a second direction, and the hook portion is moved to a second position opposite to the first direction.

11. The electronic device according to claim 9, wherein the first casing has a stopping portion connected with the elastic member.

12. The electronic device according to claim 9, wherein the elastic member is disposed on a lateral side of the pressing member.

13. The electronic device according to claim 9, wherein the pressing assembly further comprises:
a tracking member, which is connected with the connecting member.

14. The electronic device according to claim 13, further comprising:
a positioning track member, which has a plurality of grooves with bottom surfaces at different levels, wherein the tracking member is moved along the positioning track member.

15. The electronic device according to claim 9, wherein the first guide portion comprises a helical track, the second guide portion guides the first guide portion to rotate.

16. The electronic device according to claim 9, wherein the second guide portion comprises a helical track, the first guide portion is rotated along the second guide portion.
